(19) United States
(12) Patent Application Publication
(10) Pub. No.: US 2026/0085923 A1
(43) Pub. Date: Mar. 26, 2026

(54) HOLOGRAPHIC INSPECTION METHOD AND SYSTEM

(71) Applicant: Orbotech Ltd., Yavne (IL)

(72) Inventors: Elkana Porat, Yavne (IL); Nir Turko, Yavne (IL); John Linden, Yavne (IL)

(21) Appl. No.: 19/299,854

(22) Filed: Aug. 14, 2025

Related U.S. Application Data
(60) Provisional application No. 63/698,065, filed on Sep. 24, 2024.

(51) Int. Cl. G01B 9/021; G03H 1/00; G03H 1/04

(52) U.S. Cl. CPC G01B 9/021; G03H 1/0005; G03H 1/0443; G03H 1/0465; G03H 2001/005; G03H 2001/0473; G03H 2222/20

(57) ABSTRACT

The system includes a light source that emits partially coherent or coherent light split into a reference beam and an object beam and a stage that supports a workpiece in a path of the object beam that is transmitted through the workpiece. A first beam splitter combines the reference beam with the object beam transmitted through the workpiece into a combined beam, and a camera detects the combined beam. A processor generates a first interference image of the workpiece based on the combined beam, determines amplitude and phase information of the object beam based on the first interference image, generates a plurality of depth images of the workpiece based on the amplitude and phase information, determines a focus score of each pixel of the plurality of depth images, and generates a first 3D map of the workpiece based on the focus scores, which includes depth-integrated refractive index (DIRI) information.

### CROSS-REFERENCE TO RELATED APPLICATIONS

This application claims priority to the provisional patent application filed Sep. 24, 2024, and assigned U.S. Application No. 63/698,065, the disclosure of which is hereby incorporated by reference.

### FIELD OF THE DISCLOSURE

This disclosure relates to semiconductor inspection and metrology systems and, more particularly, to interferometry-based inspection and metrology systems.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor workpiece (e.g., wafer, substrate, display panel, etc.) using a large number of fabrication processes to form various features and multiple levels of the semiconductor devices. For example, lithography is a semiconductor fabrication process that involves transferring a pattern from a reticle to a photoresist arranged on a semiconductor workpiece. Additional examples of semiconductor fabrication processes include, but are not limited to, chemical-mechanical polishing (CMP), etch, deposition, and ion implantation. Multiple semiconductor devices may be fabricated in an arrangement on a single semiconductor workpiece that are separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes are also used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

Traditional methods for inspecting and characterizing transparent features often rely on digital holographic microscopy (DHM). DHM captures both optical amplitude and phase information from interference patterns resulting from the interaction between a reference beam and a sample beam. Numerical algorithms then reconstruct the complex wavefront of the sample beam, solving the inverse problem to obtain quantitative phase information.

A more advanced approach is Holographic tomography (HT). It builds upon DHM by recording complex amplitudes of transparent samples from multiple illumination directions. Numerical reconstruction techniques extract the sample's refractive index (RI) distribution in three dimensions. By accumulating data from various angles, HT enables precise characterization of transparent structures.

While DHM provides precise information on the RI distribution, it can only provide information on the “integrated” refractive index, resulting in a 2D mapping of the sample.

While HT provides 3D RI distribution, it may have large deviations from the actual RI distribution do to limiting factors such as limited angular span and registration accuracy. Additionally, HT is a relatively slow method, as many DH images are required for the 3D reconstruction. Thus, it is less suitable for inspection applications.

Therefore, what is needed is an improved system and method for inspecting and characterizing transparent features.

### BRIEF SUMMARY OF THE DISCLOSURE

An embodiment of the present disclosure provides a system. The system may comprise a light source configured to emit partially coherent or coherent light split into a reference beam and an object beam. The system may further comprise a stage configured to support a workpiece in a path of the object beam, such that the object beam is transmitted through the workpiece. The system may further comprise a first beam splitter configured to combine the reference beam with the object beam transmitted through the workpiece into a combined beam. The system may further comprise a camera configured to detect the combined beam received from the first beam splitter. The system may further comprise a processor in electronic communication with the camera. The processor may be configured to generate a first interference image of the workpiece based on the combined beam detected by the camera. The processor may be further configured to determine amplitude and phase information of the object beam based on the first interference image. The processor may be further configured to generate, using numerical propagation, a plurality of depth images of the workpiece based on the amplitude and phase information of the object beam. The processor may be further configured to determine a focus score of each pixel of the plurality of depth images. The processor may be further configured to generate a first 3D map of the workpiece based on the focus score of each pixel of the plurality of depth images. The first 3D map of the workpiece may include depth-integrated refractive index (DIRI) information.

In some embodiments, the processor may be further configured to generate a second interference image of the workpiece based on the combined beam detected by the camera with an angle of incidence of the object beam adjusted to an oblique angle relative to a first side of the workpiece. The processor may be further configured to determine amplitude and phase information of the object beam at the oblique angle based on the second interference image. The processor may be further configured to generate, using numerical propagation, a plurality of angled depth images of the workpiece based on the amplitude and phase information of the object beam at the oblique angle. The processor may be further configured to determine a focus score of each pixel of the plurality of angled depth images. The processor may be further configured to generate a second 3D map of the workpiece based on the focus score of each pixel of the plurality of angled depth images. The second 3D map of the workpiece may include DIRI information. The processor may be further configured to combine the first 3D map of the workpiece with the second 3D map of the workpiece into a combined 3D map to resolve occlusions within the workpiece.

In some embodiments, the stage may be further configured to rotate to adjust the angle of incidence of the object beam on the first side of the workpiece.

In some embodiments, the system may further comprise a beam steering element disposed in the path of the object beam. The beam steering element may be configured to adjust the angle of incidence of the object beam on the first side of the workpiece.

In some embodiments, the processor may be further configured to identify a defect in the workpiece based on the combined 3D map of the workpiece.

In some embodiments, the processor may be further configured to determine local phase perturbation of a feature of the workpiece based on the combined 3D map of the workpiece. The processor may be further configured to identify the defect in the workpiece based on the local phase perturbation.

In some embodiments, the local phase perturbation may comprise a maximum DIRI of the feature of the workpiece, local lateral dimensions of the feature of the workpiece, or DIRI uniformity across the feature of the workpiece.

In some embodiments, the processor may be further configured to determine, using an optical model, the feature of the workpiece based on the combined 3D map of the workpiece. The optical model may be configured to distinguish workpiece features from visual artifacts in the combined 3D map of the workpiece.

In some embodiments, the processor may be further configured to predict, based on an optical model, local parameters of each pixel of the first 3D map of the workpiece. The processor may be further configured to generate a map of local feature parameters based on the local parameters of each pixel of the first 3D map. The optical model may be trained based on prior knowledge of a correspondence between RI distribution and feature parameters.

Another embodiment of the present disclosure provides a method. The method may comprise emitting partially coherent or coherent light from a light source. The coherent light may be split into a reference beam and an object beam. The method may further comprise transmitting the object beam through a workpiece supported by a stage. The method may further comprise combining, with a first beam splitter, the reference beam with the object beam transmitted through the workpiece into a combined beam. The method may further comprise detecting, with a camera, the combined beam received from the first beam splitter. The method may further comprise generating, with a processor, an interference image of the workpiece based on the combined beam detected by the camera. The method may further comprise determining, with the processor, an amplitude and phase information of the object beam based on the interference image. The method may further comprise generating, with the processor, using numerical propagation, a plurality of depth images of the workpiece based on the amplitude and phase information of the object beam. The method may further comprise determining, with the processor, a focus score of each pixel of the plurality of depth images. The method may further comprise generating, with the processor, a first 3D map of the workpiece based on the focus score of each pixel of the plurality of depth images. The first 3D map of the workpiece may include depth-integrated refractive index (DIRI) information.

In some embodiments, the method may further comprise generating, with the processor, a second interference image of the workpiece based on the combined beam detected by the camera with an angle of incidence of the object beam adjusted to an oblique angle relative to a first side of the workpiece. The method may further comprise determining, with the processor, amplitude and phase information of the object beam at the oblique angle based on the second interference image. The method may further comprise generating, with the processor, using numerical propagation, a plurality of angled depth images of the workpiece based on the amplitude and phase information of the object beam at the oblique angle. The method may further comprise determining, with the processor, a focus score of each pixel of the plurality of angled depth images. The method may further comprise generating, with the processor, a second 3D map of the workpiece based on the focus score of each pixel of the plurality of angled depth images. The second 3D map of the workpiece may include DIRI information. The method may further comprise combining, with the processor, the first 3D map of the workpiece with the second 3D map of the workpiece into a combined 3D map to resolve occlusions within the workpiece.

In some embodiments, before generating, with the processor, the second interference image of the workpiece, the method may further comprise adjusting, with a beam steering element disposed in a path of the object beam, an angle of incidence of the object beam on a first side of the workpiece. The method may further comprise detecting, with the camera, the combined beam received from the beam splitter with the object beam at the oblique angle.

In some embodiments, before generating, with the processor, the second interference image of the workpiece, the method may further comprise adjusting, with the stage, the angle of incidence of the object beam on the first side of the workpiece. The method may further comprise detecting, with the camera, the combined beam received from the beam splitter with the object beam at the oblique angle.

In some embodiments, the method may further comprise identifying, with the processor, a defect in the workpiece based on the combined 3D map of the workpiece.

In some embodiments, identifying, with the processor, the defect in the workpiece based on the combined 3D map of the workpiece may comprise determining local phase perturbation of a feature of the workpiece based on the combined 3D map of the workpiece and identifying the defect in the workpiece based on the local phase perturbation.

In some embodiments, the local phase perturbation may comprise a maximum DIRI of the feature of the workpiece, local lateral dimensions of the feature of the workpiece, or DIRI uniformity across the feature of the workpiece.

In some embodiments, identifying, with the processor, the defect in the workpiece based on the combined 3D map of the workpiece may further comprise determining, with an optical model, the feature of the workpiece based on the combined 3D map of the workpiece. The optical model may be configured to distinguish workpiece features from visual artifacts in the combined 3D map of the workpiece.

In some embodiments, the method may further comprise predicting, with an optical model, local parameters of each pixel of the first 3D map of the workpiece. The method may further comprise generating, with the processor, a map of local feature parameters based on the local parameters of each pixel of the first 3D map. The optical model may be trained based on prior knowledge of a correspondence between RI distribution and feature parameters.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a diagram of a system according to another embodiment of the present disclosure;

FIG. 3 is a diagram of a system according to another embodiment of the present disclosure;

FIG. 4 is a flowchart of a method according to an embodiment of the present disclosure;

FIG. 5 is a flowchart of a method according to another embodiment of the present disclosure;

FIG. 6 is a flowchart of a method according to another embodiment of the present disclosure;

FIG. 7 is a flowchart of a method according to another embodiment of the present disclosure; and

FIG. 8 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

An embodiment of the present disclosure provides a system 100. The system 100 may be configured to perform one or more inspection or metrology processes on a workpiece 101. The workpiece 101 may be, for example, a semiconductor wafer, substrate, printed circuit board (PCB), integrated circuit (IC), flat panel display (FPD), or other type of workpiece. The workpiece 101 may be made of transparent or semi-transparent materials, such as glass, silicon, or other materials. The workpiece 101 may include embedded features that have differences in refractive index. For example, the workpiece 101 may include co-packaged optics (CPO), through silicon vias (TSV), through glass vias (TGV), advanced IC substrates (e.g., Si, SiC, or other optically transparent substrates), or on-chip photonic devices (e.g., silicon photonics). As further described below, the system 100 may be configured to quantitatively characterize the geometry and optical properties (including refractive index) of the workpiece 101 by leveraging prior knowledge about these features.

The system 100 may comprise a stage 110 configured to support the workpiece 101. The stage 110 may include one or more motors or actuators configured to move the workpiece 101 in one or more in-plane directions (e.g., along an x-axis and/or along a y-axis) and/or out-of-plane direction (e.g., along a z-axis). In some embodiments, the stage 110 may include one or more motors or actuators configured to rotate the workpiece 101 about any of the x-axis, the y-axis, or the z-axis.

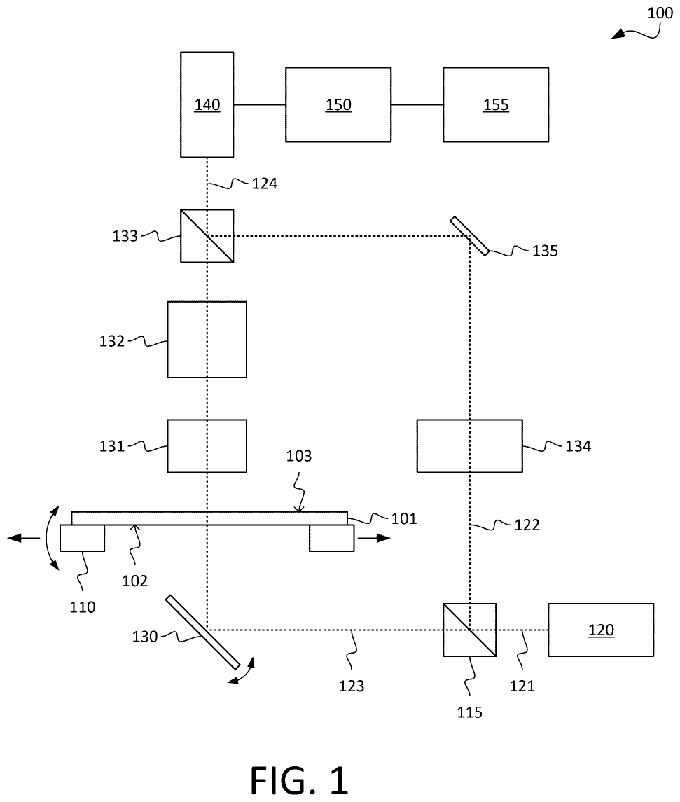

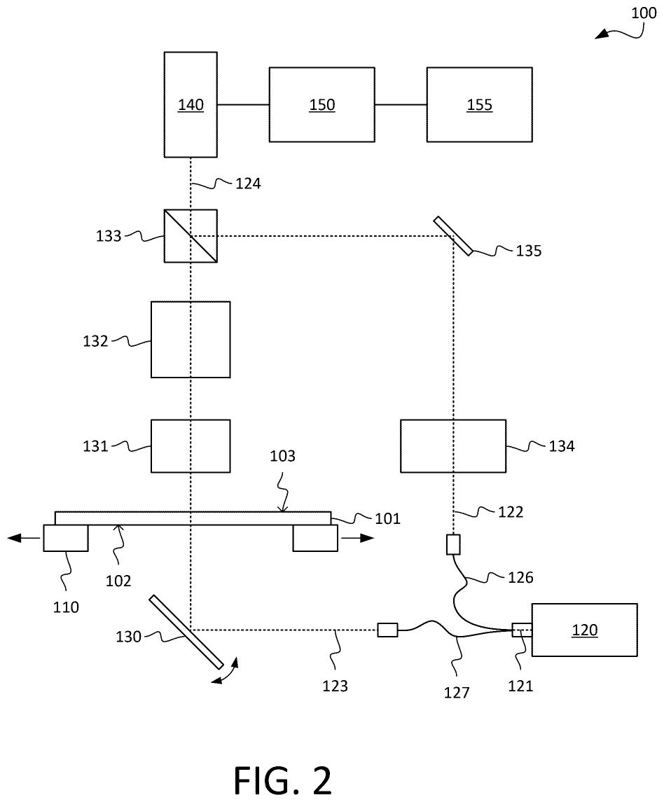

The system 100 may further comprise a light source 120. The light source 120 may be configured to emit partially coherent or coherent light 121. In some embodiments, the system 100 may further comprise a second beam splitter 115 configured to split the coherent light 121 from the light source 120 into a reference beam 122 and an object beam 123, as shown in FIG. 1. In some embodiments, the system 100 may further comprise a first fiber optic cable 126 and a second fiber optic cable 127 configured to split the coherent light 121 from the light source 120 into the reference beam 122 and the object beam 123, as shown in FIG. 2. The wavelength of the coherent light 121 emitted by the light source 120 may depend on the type of workpiece 101 being inspected. For example, visible light (having a wavelength in a range of 400 to 600 nm) may be used for glass substrates, and infrared light (having a wavelength in a range of 900 to 1100 nm) may be used for silicon substrates. The wavelength of the coherent light 121 may vary so long as it is transmissive enough and sensitive enough to the refractive indexes of features of the workpiece 101. In addition, the coherence length of the coherent light 121 may depend on the thickness of the workpiece 101. In particular, the light source 120 may be chosen/calibrated so that the coherence length of the coherent light 121 is longer than the thickness of the workpiece 101, which may ensure that interference is affected by the full thickness of the workpiece 101. For example, if the workpiece 101 has a thickness of 500 μm, the coherence length of the coherent light 121 may be greater than 500 μm. In an instance, the coherence length of the coherent light 121 may be two-times the thickness of the workpiece 101.

The stage 110 may be positioned such that the object beam 123 is transmitted through the workpiece 101. For example, the object beam 123 may be directed at a first side 102 of the workpiece 101 and transmitted through a second side 103 of the workpiece 101.

The system 100 may further comprise a beam steering element 130. The beam steering element 130 may be configured to adjust an angle of incidence of the object beam 123 on the first side 102 of the workpiece 101. For example, the beam steering element 130 may ensure normal incidence of the object beam 123 on the first side 102 of the workpiece 101 or may adjust the angle of incidence to one or more oblique angles. Normal incidence may center the main frequency of the interference in the FFT transform relative to the NA frequency limit. In some embodiments, the beam steering element 130 may be omitted, with the stage 110 being used to rotate the workpiece 101 to ensure normal incidence of the object beam 123 on the first side 102 of the workpiece 101 or may adjust the angle of incidence to one or more oblique angles.

In some embodiments, the beam steering element 130 may comprise a fast scanning mirror (FSM). An FSM can rapidly change the angle of a beam by reflecting it off a mirror that can tilt in different directions. When used in conjunction with an infinity-corrected objective, the FSM can focus and scan the beam at the back focal plane, resulting in a collimated beam that can be steered precisely. An FSM can provide high-speed and precise control of the beam angle, making it suitable for dynamic applications.

In some embodiments, the beam steering element 130 may comprise a galvanometer mirror. Similar to FSMs, galvanometer mirrors use rotating mirrors driven by galvanometers to steer the beam. These mirrors can achieve high-speed scanning and are often used in laser scanning systems. These mirrors can also offer fast response times and high precision, suitable for applications requiring rapid beam steering.

In some embodiments, the beam steering element 130 may comprise an acousto-optic deflector (AOD). AODs use sound waves to create a diffraction grating in an acousto-optic material. By changing the frequency of the sound waves, the angle of the diffracted beam can be controlled. AODs can also offer fast and precise beam steering with the ability to control the beam angle electronically.

In some embodiments, the beam steering element 130 may comprise a micro-electro-mechanical system (MEMS) mirror. MEMS mirrors are tiny mirrors that can tilt in multiple directions using electrostatic or electromagnetic forces. These mirrors can be used to steer the beam with high precision. MEMS mirrors can provide compact and low-power solutions for beam steering, suitable for portable and miniaturized systems.

In some embodiments, the beam steering element 130 may comprise an electro-optic beam deflector. These devices use the electro-optic effect to change the refractive index of a material, thereby steering the beam. By applying a voltage, the beam can be deflected to different angles. These devices can offer fast response times and precise control, suitable for high-speed applications.

While several exemplary types of beam steering elements 130 are described herein, each may achieve precise and dynamic control of the beam angle in transmission mode, and the type of beam steering element 130 may be selected depending on the specific application requirements. In addition, some types of beam steering elements 130 (e.g., AODs and electro-optic beam deflectors) may utilize optical relays to provide a full range of AOIs.

In some embodiments, the system may further comprise a liquid crystal spatial light modulator (LC-SLM). LC-SLMs can modulate the phase of the incoming light beam, allowing for phase correction of the beam top optimize aberrations that can be dynamic due to noise or depth of embedded features in the workpiece 101. An SLM can also be used to multiplex multiple angles of incidence (AOI) at a time. Similarly, a diffractive optical element can be used for semi-dynamic adjustments per type of workpiece 101. In some embodiments, multiplexing AOIs can be used instead of dynamic beam steering with a beam steering element 130.

The system 100 may further comprise an objective lens 131 disposed in the path of the object beam 123 transmitted through the workpiece 101. The system 100 may further comprise a tube lens 132 in the path of the object beam 123 transmitted through the workpiece 101. The system 100 may further comprise any number of other optical elements disposed in the path of the object beam 123 transmitted through the workpiece 101 and is not limited herein. For example, the system 100 may further comprise diffractive optical elements for phase control and/or a spatial light modulator (SLM) for phase modifications of the object beam 123.

The system 100 may further comprise a first beam splitter 133. The first beam splitter 133 may be configured to combine the reference beam 122 with the object beam 123 transmitted through the workpiece 101 into a combined beam 124.

The system 100 may further comprise a beam expander 134 disposed in the path of the reference beam 122. The system 100 may further comprise a reference mirror 135 disposed in the path of the reference beam 122, which may be configured to direct the reference beam 122 to the beam splitter 133.

The system 100 may further comprise any number of other optical elements disposed in the path of the reference beam 122 and/or the object beam 123 and is not limited herein. For example, the system 100 may further comprise a beam expander, collimating optics, diffractive optics for phase uniformity, intensity filters, variable length motion controllers to match the optical path difference changes, and/or polarization rotation elements for optimal interference of the reference beam 122 with the object beam 123.

The system 100 may further comprise a camera 140. The camera 140 may be configured to detect the combined beam 124 received from the first beam splitter 133.

The system 100 may further comprise a processor 150. The processor 150 may include a microprocessor, a microcontroller, field programmable gate array (FPGA), or other devices. The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the stage 110. For example, the processor 150 may be configured to send instructions or the one or more actuators of the stage 110 to move the stage 110 relative to the object beam 123 (e.g., along the x-axis and/or along the y-axis) to adjust the alignment of the object beam 123 relative to the first side 102 of the workpiece 101. The position of the stage 110 may be further adjusted (i.e., along the z-axis) based on the thickness of the workpiece 101. In some embodiments, the processor 150 may be further configured to send instructions to the one or more motors or actuators of the stage 110 to rotate the stage 110 (e.g., about the x-axis and/or about the y-axis) relative to the object beam 123 to adjust the angle of incidence (AOI) of the object beam 123 on the first side 102 of the workpiece 101.

The processor 150 may be in electronic communication with the light source 120. For example, the processor 150 may be configured to send instructions to the light source 120 to emit the partially coherent or coherent light 121.

The processor 150 may be in electronic communication with the beam steering element 130. For example, the processor 150 may be configured to send instructions to the beam steering element 130 to adjust the angle of incidence (AOI) of the object beam 123 on the first side 102 of the workpiece 101.

The processor 150 may be in electronic communication with the camera 140. For example, the processor 150 may be configured to receive signals based on the combined beam 124 detected by the camera 140. The processor 150 may be configured to generate an interference image of the workpiece 101 based on the combined beam 124 detected by the camera 140. The processor 150 may be further configured to determine amplitude and phase information of the object beam 123 based on the interference image. The processor 150 may use a filtered backpropagation algorithm to retrieve the amplitude and phase of the object beam 123. In some embodiments, the filtered backpropagation algorithm may use or not use noise reduction methods.

The processor 150 may be further configured to generate, using numerical propagation, a plurality of depth images of the workpiece 101 based on the amplitude and phase information of the object beam 123. For example, the processor 150 may apply the Angular Spectrum or Fresnel Diffraction method to extract amplitude data and determine the specific geometry of each plane to generate the plurality of depth images of the workpiece 101.

In some embodiments, the plurality of depth images of the workpiece 101 may comprise a first depth image, a second depth image, and at least one third depth image collected at each AOI. The first depth image may be aligned at a depth corresponding to the first side 102 of the workpiece 101. The second depth image may be aligned at a depth corresponding to the second side 103 of the workpiece 101. The at least one third depth image may be aligned at one or more depths between the first side 102 of the workpiece 101 and the second side 103 of the workpiece 101. In an instance, the at least one third depth image may be aligned at a depth that is a midpoint between the first side 102 of the workpiece 101 and the second side 103 of the workpiece 101. The difference in depths between each depth image may vary, depending on the thickness of the workpiece 101. In an instance, the difference in depths between each depth image may range from several μm to tens of μm. The plurality of depth images of the workpiece 101 may therefore resolve internal and transparent structures of the workpiece 101 through digital holography of a single image.

The processor 150 may be further configured to determine a focus score of each pixel of the plurality of depth images of the workpiece. This process may propagate the wavefront and give a value for each image/sub-slice of an image. The focus score may then be used for a minimization algorithm to determine the best focus plane for the slice. The plane can be propagated non-sequentially but various methods such as Newton-Raphson, Parabolic-interpolation, Gradient Descent, or Bayesian.

In some embodiments, the focus score may be calculated using a Tamura coefficient. The Tamura coefficient may be calculated based on the standard deviation and the mean of intensity of each pixel, which may be effective for amplitude-based depth-from-focus (DFF) reconstructions, and may be used in pixel-wise focus scoring for 3D mapping.

In some embodiments, the focus score may be calculated using an average gradient. The average gradient may be calculated based on the mean of gradient magnitude of the plurality of depth images of the workpiece. Using the average gradient can be fast and simple, best for clean, edge-rich workpieces, and can be sensitive to noise.

In some embodiments, the focus score may be calculated using a standard deviation of gradient. The standard deviation of gradient may measure the spread of gradient magnitudes of the plurality of depth images of the workpiece. This may balance sensitivity and robustness, and may be suitable for general-purpose autofocus.

In some embodiments, the focus score may be calculated using a median gradient. The median gradient may be a median of gradient magnitudes of the plurality of depth images of the workpiece. This may be more robust to outliers and speck, and can be suitable for noisy holograms.

In some embodiments, the focus score may be calculated using a total variation (TV). The TV may be calculated using a sum of absolute gradient magnitudes of the plurality of depth images of the workpiece. This may be used for detecting sharp transitions, and can be suitable for high-NA or phase sensitive systems.

The processor 150 may be further configured to generate a first 3D map of the workpiece 101 based on the focus score of each pixel of the plurality of depth images. The first 3D map of the workpiece may include depth-integrated refractive index (DIRI) information, which can be used for mapping and identification of local features.

In some embodiments, some features in the first 3D map may be occluded by others. Accordingly, the processor 150 may be configured to send instructions to the stage 110 or to the beam steering element 130 to adjust an angle of incidence of the object beam 123 on the first side 102 of the workpiece 101 to collect additional information at a different illumination angle. The different illumination angle may be, for example, an oblique angle (e.g., 25 degrees), while the original angle of incidence of the object beam 123 was normal to the first side 102 of the workpiece 101 (e.g., 0 degrees) or at a different angle. The range of adjustment of the illumination angle may depend on the numerical aperture (NA) of the objective lens 131. The processor 150 may be configured to generate a second interference image of the workpiece 101 based on the combined beam 124 detected by the camera 140 with an the of incidence of the object beam 123 adjusted to an oblique angle relative to the first side 102 of the workpiece 101. The processor may be further configured to determine amplitude and phase information of the object beam 123 at the oblique angle based on the second interference image. The processor 150 may be further configured to generate, using numerical propagation, a plurality of angled depth images of the workpiece 101 based on the amplitude and phase information of the object beam 123 at the oblique angle. The processor 150 may be further configured to determine a focus score of each pixel of the plurality of angled depth images. The processor 150 may be further configured to generate a second 3D map of the workpiece 101 based on the focus score of each pixel of the plurality of angled depth images. The second 3D map of the workpiece includes DIRI information. The second 3D map of the workpiece may be at an angle relative to the first 3D map, based on the different illumination angle. Accordingly, occluded structures in the first 3D map may now be clear in the line of sight of the second 3D map. The processor 150 may be further configured to combine the first 3D map of the workpiece with the second 3D map of the workpiece into a combined 3D map to resolve occlusions within the workpiece 101. The combined analysis of the first 3D map and the second 3D map may use a geometric model of the workpiece 101 to resolve differences in the object beam 123 transmitted through the workpiece 101 due to tilt and refraction (which causes lateral and axial separation of the combined beam 124 received by the camera 140) into a combined 3D map without occlusions error.

In some embodiments, additional interference images may be collected at different angles of incidence. A 3D map can be generated at each angle of incidence using the depth from focus procedure described above, and each 3D map can be combined into the combined 3D map. In general, different angles of incidence can provide additional information that improves the accuracy of identified local features.

In some embodiments, the light source 120 may comprise a tunable light source or the system 100 may comprise more than one light source 120 for multiplexing different wavelengths of light 121. A 3D map can be generated with each different wavelength using the depth from focus procedure described above, and each 3D map can be combined into the combined 3D map. In general, different wavelengths can provide additional information that improves that accuracy of identified local features.

In some embodiments, the processor 150 may be further configured to identify a defect in the workpiece 101 based on the combined 3D map of the workpiece. For example, the processor 150 may be further configured to determine local phase perturbation of a feature of the workpiece 101 based on the combined 3D map of the workpiece and identify the defect in the workpiece 101 based on the local phase perturbation. The local phase perturbation may comprise a maximum DIRI of the feature of the workpiece 101, local lateral dimensions of the feature of the workpiece 101, DIRI uniformity across the feature of the workpiece 101, or other parameters of interest. In an instance, the processor 150 may perform first numerical propagation over the whole workpiece 101 and the proper focus may be determined for each feature. While some visual artifacts that can be ignored, each feature can be analyzed at their determined proper focus point to identify defects. This can reduce the noise from reconstruction artifacts to conduct the actual inspection. In some embodiments, the processor 150 may use model-based reconstruction to reduce artifacts from propagation. This can be done by optical simulation using machine-learning modeling or neural networks (e.g., convolutional neural networks (CNN)) to distinguish workpiece features from visual artifacts for error reduction.

In some embodiments, the processor 150 may be further configured to predict, based on an optical model, local parameters of each pixel of the first 3D map of the workpiece 101. The optical model may be trained based on prior knowledge of a correspondence between RI distribution and feature parameters. For example, prior knowledge can be general shape (e.g., cylinder, ellipsoid, squared, etc.), internal RI distribution (e.g., uniform, gaussian, etc.), internal symmetry (e.g., radial, rotational, reflexive or anti-reflexive symmetry, etc.) or others. In some cases, prior knowledge may include a complex structure, e.g., computer aided design (CAD). The processor 150 may be further configured to generate a map of local feature parameters based on the local parameters of each pixel of the first 3D map. Generally, for any n number of local parameters, at least n DHM images at different illumination angles may be taken. At each illumination angle, the phase profile includes a projection of the feature's RI distribution by the illumination angle. Thus, each phase profile is analyzed to return local parameters of the projection. Finally, the local parameters of the feature are fitted to the local parameters of the different projection, to return a map of local feature parameters. The parameter maps can be then further analyzed to detect defects, sample uniformity, abnormalities or other global properties of the workpiece 101. The defects may include, for example, nonuniformities in RI or thickness of the workpiece 101, voids, or cracks in the workpiece 101.

For example, for a feature with an elongated, wire-like, elliptic cross section, the local structure of the feature may be parametrized by its major and minor axes, its rotation angle, and its RI. For this example, at least three interference images at different illumination angles are taken. For each illumination angle, the procedure described above is used to determine the local phase profile of any feature. Then, the local width and amplitude of the DIRI are extracted from any local phase profile. Finally, the local feature parameters are calculated or fitted based on the local projection parameters.

In some embodiments, instead of extracting the local projection properties, an elaborate optical model may be used to compare a model prediction directly to the set of projected phase images. Alternatively, a Machine Learning (ML) algorithm may be used to infer the feature properties directly from the set of projected phase images. Examples of ML algorithm may include neural networks (e.g., CNN), Bayesian inference, or other ML algorithm. Training of the ML algorithm may be performed using elaborate optical modelling of the features and the inspection system.

The system 100 may further comprise an electronic data storage unit 155. The electronic data storage unit 155 may be in electronic communication with the processor 150. The optical model and/or ML algorithm may be stored on the electronic data storage unit 155.

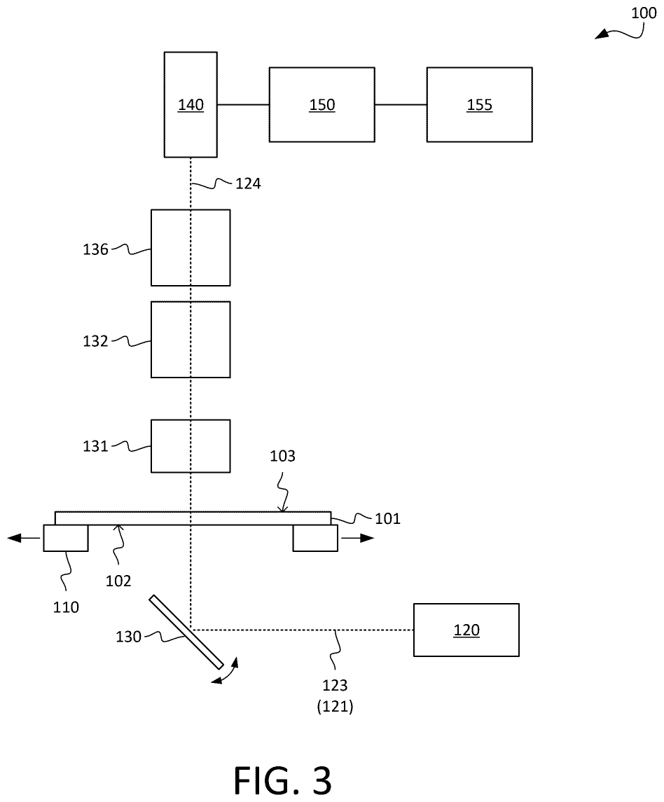

In some embodiments, as illustrated in FIG. 3, the light from the light source 120 may not be split into the reference beam 122 and the object beam 123, and instead all of the light may be directed to the workpiece 101 and may share a common path, which minimizes the optical path difference. Then, the light transmitted through the workpiece 101 can be directed to a common-path interferometer module 136, which may split the light into two light beams (one through a spatial filter) and then recombined into the combined beam 124 to enable amplitude and phase demodulation of the two light beams. This configuration may enhance stability and reduce sensitivity to vibrations and environmental changes. This configuration may also be highly stable and compact, which may be suitable for environments with significant external perturbations.

With the system 100, 3D characterization of both feature location and internal structure can be achieved, while allowing for high throughput for inspection applications. In addition, information can be collected at more than one angle to resolve occlusions in transparent features and features located in a transparent workpiece 101 and improve resolution in all axes of imaging.

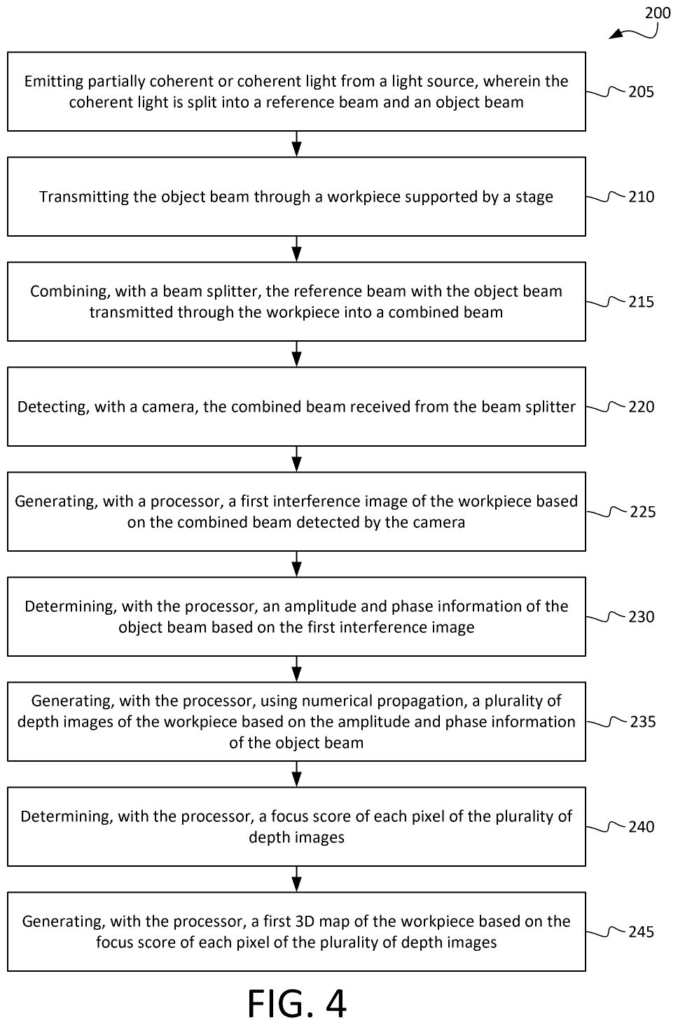

Another embodiment of the present disclosure provides a method 200. As shown in FIG. 4, the method 200 may comprise the following steps.

At step 205, partially coherent or coherent light is emitted from a light source. The light may be split into a reference beam and at least one object beam.

At step 210, the object beam is transmitted through a workpiece supported by a stage.

At step 215, a beam splitter combines the reference beam with the object beam transmitted through the workpiece into a combined beam.

At step 220, a camera detects the combined beam received from the beam splitter.

At step 225, a processor generates a first interference image of the workpiece based on the combined beam detected by the camera.

At step 230, the processor determines amplitude and phase information of the object beam based on the first interference image.

At step 235, the processor generates, using numerical propagation, a plurality of depth images of the workpiece based on the amplitude and phase information of the object beam.

At step 240, the processor determines a focus score of each pixel of the plurality of depth images.

At step 245, the processor generates a first 3D map of the workpiece based on the focus score of each pixel of the plurality of depth images. The first 3D map of the workpiece may include depth-integrated refractive index information.

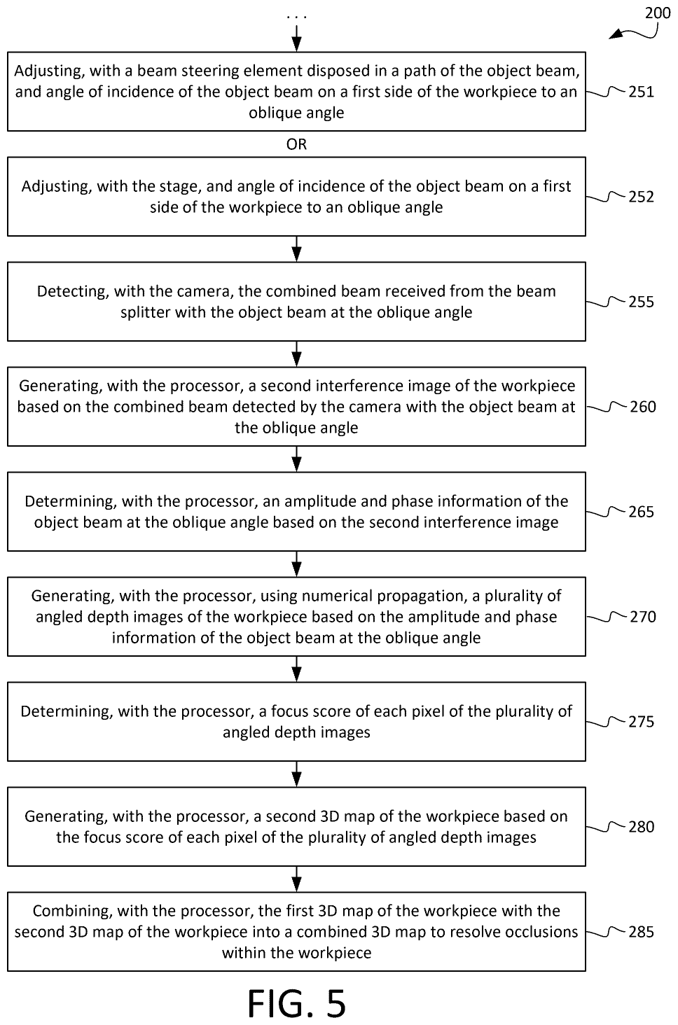

In some embodiments, some features of the first 3D map may be occluded by others. Accordingly, the method 200 may further include step 251 or step 252, as shown in FIG. 5. At step 251, a beam steering element disposed in a path of the object beam adjusts an angle of incidence of the object beam on a first side of the workpiece. Alternatively, at step 252, the stage adjusts the angle of incidence of the object beam on the first side of the workpiece.

After adjusting the angle of incidence of the object beam in step 251 or step 252, the method 200 may further comprise the following steps.

At step 255, the camera detects the combined beam received from the beam splitter with the object beam at the oblique angle.

At step 260, the processor generates a second interference image of the workpiece based on the combined beam detected by the camera with the object beam at the oblique angle.

At step 265, the processor determines amplitude and phase information of the object beam at the oblique angle based on the second interference image.

At step 270, the processor generates, using numerical propagation, a plurality of angled depth images of the workpiece based on the amplitude and phase information of the object beam at the oblique angle.

At step 275, the processor determines a focus score of each pixel of the plurality of angled depth images.

At step 280, the processor generates a second 3D map of the workpiece based on the focus score of each pixel of the plurality of angled depth images. The second 3D map of the workpiece includes depth-integrated refractive index information.

At step 285, the processor combines the first 3D map of the workpiece with the second 3D map of the workpiece into a combined 3D map to resolve occlusions within the workpiece.

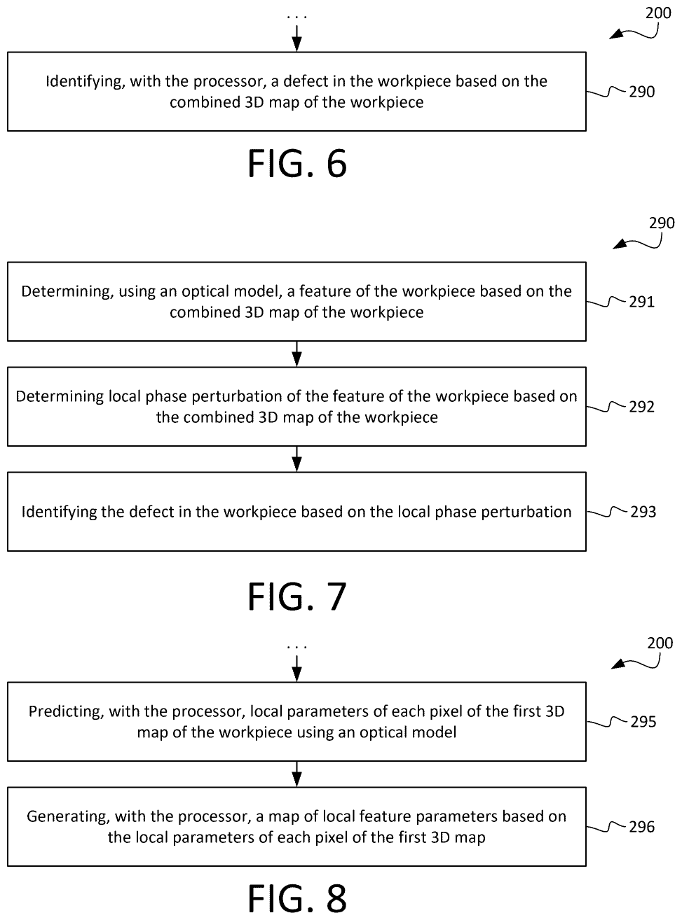

In some embodiments, the method 200 may further comprise step 290, as shown in FIG. 6. At step 290, the processor identifies a defect in the workpiece based on the combined 3D map of the workpiece.

In some embodiments, step 290 may comprise the following steps shown in FIG. 7.

At step 291, the processor determines, using an optical model, a feature of the workpiece based on the combined 3D map of the workpiece. The optical model may perform optical simulation using machine-learning modeling or neural networks (e.g., convolutional neural networks (CNN)) to distinguish workpiece features from visual artifacts for error reduction.

At step 292, the processor determines local phase perturbation of the feature of the workpiece based on the combined 3D map of the workpiece. The local phase perturbation may comprise, for example, a maximum DIRI of the feature of the workpiece, local lateral dimensions of the feature of the workpiece, or DIRI uniformity across the feature of the workpiece.

At step 293, the processor identifies the defect in the workpiece based on the local phase perturbation.

In some embodiments, the method 200 may further comprise the following steps, shown in FIG. 8.

At step 295, the processor predicts local parameters of each pixel of the first 3D map of the workpiece using an optical model. The optical model is trained based on prior knowledge of a correspondence between RI distribution and feature parameters.

At step 296, the processor generates a map of local feature parameters based on the local parameters of each pixel of the first 3D map.

In some embodiments, the processor may predict local parameters of each pixel of the combined 3D map of the workpiece rather than the first 3D map of the workpiece, and the processor may generate a map of local feature parameters based on the local parameters of each pixel of the combined 3D map.

With the method 200, 3D characterization of both feature location and internal structure can be achieved, while allowing for high throughput for inspection applications. In addition, information can be collected at more than one angle to resolve occlusions in transparent features and features located in a transparent workpiece and improve resolution in all axes of imaging.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
a light source configured to emit partially coherent or coherent light split into a reference beam and an object beam;
a stage configured to support a workpiece in a path of the object beam, such that the object beam is transmitted through the workpiece;
a first beam splitter configured to combine the reference beam with the object beam transmitted through the workpiece into a combined beam;
a camera configured to detect the combined beam received from the first beam splitter; and
a processor in electronic communication with the camera, wherein the processor is configured to:
generate a first interference image of the workpiece based on the combined beam detected by the camera;
determine amplitude and phase information of the object beam based on the first interference image;
generate, using numerical propagation, a plurality of depth images of the workpiece based on the amplitude and phase information of the object beam;
determine a focus score of each pixel of the plurality of depth images; and
generate a first 3D map of the workpiece based on the focus score of each pixel of the plurality of depth images, wherein the first 3D map of the workpiece includes depth-integrated refractive index (DIRI) information.

2. The system of claim 1, wherein the processor is further configured to:
generate a second interference image of the workpiece based on the combined beam detected by the camera with an angle of incidence of the object beam adjusted to an oblique angle relative to a first side of the workpiece;
determine amplitude and phase information of the object beam at the oblique angle based on the second interference image;
generate, using numerical propagation, a plurality of angled depth images of the workpiece based on the amplitude and phase information of the object beam at the oblique angle;
determine a focus score of each pixel of the plurality of angled depth images;
generate a second 3D map of the workpiece based on the focus score of each pixel of the plurality of angled depth images, wherein the second 3D map of the workpiece includes DIRI information; and
combine the first 3D map of the workpiece with the second 3D map of the workpiece into a combined 3D map to resolve occlusions within the workpiece.

3. The system of claim 2, wherein the stage is further configured to rotate to adjust the angle of incidence of the object beam on the first side of the workpiece.

4. The system of claim 2, further comprising:
a beam steering element disposed in the path of the object beam and configured to adjust the angle of incidence of the object beam on the first side of the workpiece.

5. The system of claim 2, wherein the processor is further configured to identify a defect in the workpiece based on the combined 3D map of the workpiece.

6. The system of claim 5, wherein the processor is further configured to:
determine local phase perturbation of a feature of the workpiece based on the combined 3D map of the workpiece; and
identify the defect in the workpiece based on the local phase perturbation.

7. The system of claim 6, wherein the local phase perturbation comprises a maximum DIRI of the feature of the workpiece, local lateral dimensions of the feature of the workpiece, or DIRI uniformity across the feature of the workpiece.

8. The system of claim 6, wherein the processor is further configured to:
determine, using an optical model, the feature of the workpiece based on the combined 3D map of the workpiece, wherein the optical model is configured to distinguish workpiece features from visual artifacts in the combined 3D map of the workpiece.

9. The system of claim 1, wherein the processor is further configured to:
predict, based on an optical model, local parameters of each pixel of the first 3D map of the workpiece; and
generate a map of local feature parameters based on the local parameters of each pixel of the first 3D map.

10. The system of claim 9, wherein the optical model is trained based on prior knowledge of a correspondence between RI distribution and feature parameters.

11. A method comprising:
emitting partially coherent or coherent light from a light source, wherein the coherent light is split into a reference beam and an object beam;
transmitting the object beam through a workpiece supported by a stage;
combining, with a first beam splitter, the reference beam with the object beam transmitted through the workpiece into a combined beam;
detecting, with a camera, the combined beam received from the first beam splitter;
generating, with a processor, an interference image of the workpiece based on the combined beam detected by the camera;
determining, with the processor, an amplitude and phase information of the object beam based on the interference image;
generating, with the processor, using numerical propagation, a plurality of depth images of the workpiece based on the amplitude and phase information of the object beam;
determining, with the processor, a focus score of each pixel of the plurality of depth images; and
generating, with the processor, a first 3D map of the workpiece based on the focus score of each pixel of the plurality of depth images, wherein the first 3D map of the workpiece includes depth-integrated refractive index (DIRI) information.

12. The method of claim 11, further comprising:
generating, with the processor, a second interference image of the workpiece based on the combined beam detected by the camera with an angle of incidence of the object beam adjusted to an oblique angle relative to a first side of the workpiece;
determining, with the processor, amplitude and phase information of the object beam at the oblique angle based on the second interference image;
generating, with the processor, using numerical propagation, a plurality of angled depth images of the workpiece based on the amplitude and phase information of the object beam at the oblique angle;
determining, with the processor, a focus score of each pixel of the plurality of angled depth images;
generating, with the processor, a second 3D map of the workpiece based on the focus score of each pixel of the plurality of angled depth images, wherein the second 3D map of the workpiece includes DIRI information; and
combining, with the processor, the first 3D map of the workpiece with the second 3D map of the workpiece into a combined 3D map to resolve occlusions within the workpiece.

13. The method of claim 12, wherein before generating, with the processor, the second interference image of the workpiece, the method further comprises:
adjusting, with a beam steering element disposed in a path of the object beam, an angle of incidence of the object beam on a first side of the workpiece; and
detecting, with the camera, the combined beam received from the first beam splitter with the object beam at the oblique angle.

14. The method of claim 12, wherein before generating, with the processor, the second interference image of the workpiece, the method further comprises:
adjusting, with the stage, the angle of incidence of the object beam on the first side of the workpiece; and
detecting, with the camera, the combined beam received from the first beam splitter with the object beam at the oblique angle.

15. The method of claim 12, further comprising:
identifying, with the processor, a defect in the workpiece based on the combined 3D map of the workpiece.

16. The method of claim 15, wherein identifying, with the processor, the defect in the workpiece based on the combined 3D map of the workpiece comprises:
determining local phase perturbation of a feature of the workpiece based on the combined 3D map of the workpiece; and
identifying the defect in the workpiece based on the local phase perturbation.

17. The method of claim 16, wherein the local phase perturbation comprises a maximum DIRI of the feature of the workpiece, local lateral dimensions of the feature of the workpiece, or DIRI uniformity across the feature of the workpiece.

18. The method of claim 16, wherein identifying, with the processor, the defect in the workpiece based on the combined 3D map of the workpiece further comprises:
determining, with an optical model, the feature of the workpiece based on the combined 3D map of the workpiece, wherein the optical model is configured to distinguish workpiece features from visual artifacts in the combined 3D map of the workpiece.

19. The method of claim 11, further comprising:
predicting, with an optical model, local parameters of each pixel of the first 3D map of the workpiece; and
generating, with the processor, a map of local feature parameters based on the local parameters of each pixel of the first 3D map.

20. The method of claim 19, wherein the optical model is trained based on prior knowledge of a correspondence between RI distribution and feature parameters.
